(19) United States
(12) Patent Application Publication
(10) Pub. No.: US 2020/0068081 A1
(43) Pub. Date: Feb. 27, 2020

(54) IMAGE INSPECTION DEVICE AND PROGRAM

(71) Applicant: KONICA MINOLTA, INC., Tokyo (JP)

(72) Inventor: Takao KUROHATA, Tokyo (JP)

(73) Assignee: KONICA MINOLTA, INC., Tokyo (JP)

(21) Appl. No.: 16/508,413

(22) Filed: Jul. 11, 2019

(30) Foreign Application Priority Data
Aug. 23, 2018 (JP) 2018-156365

(51) Int. Cl. H04N 1/00

(52) U.S. Cl. CPC H04N 1/00718; H04N 1/00734; H04N 1/00042; H04N 1/00045; H04N 1/00082; H04N 1/00005

(57) ABSTRACT

An image inspection device includes: a hardware processor that acquires a read image obtained by reading an image on a recording medium on which the image is formed, prepares a comparison image from the read image by sectioning an inspection region in a certain unit, and determines normality/abnormality of an image based on the comparison image; and a skew detector that detects a skewed state caused by meandering of the recording medium, wherein the hardware processor receives detected information from the skew detector, and inclines an image on the inspection region in accordance with the detected information to determine the normality/abnormality of the image.

The entire disclosure of Japanese patent Application No. 2018-156365, filed on Aug. 23, 2018, is incorporated herein by reference in its entirety.

### BACKGROUND

### Technological Field

The present invention relates to an image inspection device and a program which determine normality/abnormality of an image based on a read image read from a recording medium.

### Description of the Related Art

In the technical field of image forming apparatuses such as a copying machine, a printer, and a multi-function machine, there is a known method by which normality/abnormality of an image is determined by using read image data obtained by reading an image on paper.

For example, abnormality such as stain, color deviation, or positional displacement is determined by comparing a read image with a correct image such as image data for printing to determine whether the read image conforms to the correct image, or a malfunction part of a machine is diagnosed by detecting streak information and the like by a malfunction diagnosis function. Such determination is generally referred to as defective print determination. Such defective print determination is also performed not only for cut paper but also for continuous-form paper such as roll paper.

For example, JP 1-311377 A proposes a defect inspection device that optically and continuously detects a defective part from image data obtained by imaging, with an image sensor camera, a long sheet-like inspection object on which image patterns are repeatedly formed. This device is provided with functions to: automatically learn a mask pattern based on image data representing repeated image patterns which are acquired by imaging and formed on the inspection object; and execute mask processing while simultaneously learning every repeated pitch of the patterns contained in the image data. As a result, it is said that accumulation of pitch errors caused in initial setting of the mask pattern is eliminated and accuracy of defect inspection is improved.

Furthermore, JP 9-109372 A discloses a product inspection device including: a product inspection means to inspect presence/absence of a defective part of a sheet-like printed product; a marking means to attach an identification mark to a product that has been detected to have a defective part by the product inspection means; and a mark presence/absence inspection means to inspect whether the identification mark is attached to a concerned part of the product that has the defective part. In this device, inspection is executed on a printed matter produced in one cycle, an attachment failure or the like of the identification mark by the marking means can be surely inspected, and it is possible to preliminarily prevent a defective product from outflowing to a market due to erroneous detachment of the identification mark.

By the way, in a case of applying above-mentioned known technologies to a printer using long paper or roll paper, when defective print detection is executed in unit of paper, skew of the paper cannot be corrected until entire printing is completed. As a result, there may be problems that a real-time property of defective print detection is impaired and cost increase is caused by securing a huge memory to save/correct read image. Considering this, the real-time property of the defective print detection can be secured and the cost increase caused by securing the huge memory can be suppressed by sectioning the paper in a certain unit and executing the skew correction.

However, the roll paper or the like often meanders in the printing using the roll paper or the like, and in the case where the roll paper or the like meanders, the paper is partly skewed. In the case where the roll paper is skewed during conveyance, when a read image is compared with a normal image as it is, the read image is determined as an abnormal image that is skewed with respect to the normal image, and there may be a problem that defective print detection cannot be normally executed.

### SUMMARY

The present invention is made in view of the above-described situation and is directed to providing an image inspection device and a program in which in a case where a recording medium is skewed, normal detection can be executed by correcting an inspection region of a certain unit in accordance with the skew.

To achieve the abovementioned object, according to an aspect of the present invention, an image inspection device reflecting one aspect of the present invention comprises: a hardware processor that acquires a read image obtained by reading an image on a recording medium on which the image is formed, prepares a comparison image from the read image by sectioning an inspection region in a certain unit, and determines normality/abnormality of an image based on the comparison image; and a skew detector that detects a skewed state caused by meandering of the recording medium, wherein the hardware processor receives detected information from the skew detector, and inclines an image on the inspection region in accordance with the detected information to determine the normality/abnormality of the image.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a mechanical schematic diagram illustrating an image forming apparatus including an image inspection device according to an embodiment of the present invention;

FIG. 2 is a diagram illustrating a control block of the same;

FIG. 3 illustrates diagrams to describe a state in which an image on roll paper is read in a sectioned region and inspection is executed;

FIG. 4 illustrates: an upper diagram to describe a state in which image inspection cannot be normally executed due to skew of the roll paper; and a lower diagram to describe a state in which image inspection is normally executed while inclining an image of a sectioned region in consideration of the skewed image;

FIG. 5 illustrates: an upper diagram to describe a state in which image inspection cannot be normally executed due to skew of the roll paper; and a lower diagram to describe a state in which image inspection is normally executed using an image in a sectioned region by skewing a read image;

FIG. 6 is a diagram to describe a state of enlarging a sectioned region in a case where image chipping is caused in a comparison image;

FIG. 7 is a diagram to describe a state in which sectioned regions overlap with each other when a large region is secured so as to prevent image chipping due to skew from occurring in a sectioned region of a certain unit;

FIG. 8 is a diagram to describe a state in which inspection is executed by dividing an inspection region in a case where the inspection region is large and a skew amount is different between a leading end and a tail end thereof;

FIG. 9 is a view illustrating a screen on which a warning is displayed because the paper largely meanders;

FIG. 10 is a view illustrating an operation display screen displayed in a case where it is predicted from tendency of skew that image inspection cannot be normally executed in future;

FIGS. 11A and 11B are a flowchart illustrating a procedure of detecting skew of an image, acquiring a sectioned image; and executing image inspection by correcting the skew/positional deviation on the sectioned image based on detected information; and

FIGS. 12A and 12B are a flowchart illustrating a procedure of detecting skew of an image, acquiring a sectioned image after correcting the skew/positional deviation on a read image based on detected information, and executing image inspection.

### DETAILED DESCRIPTION OF EMBODIMENTS

Hereinafter, one or more embodiments of an image forming apparatus including an image inspection device of the present invention will be described with reference to the drawings. However, the scope of the invention is not limited to the disclosed embodiments.

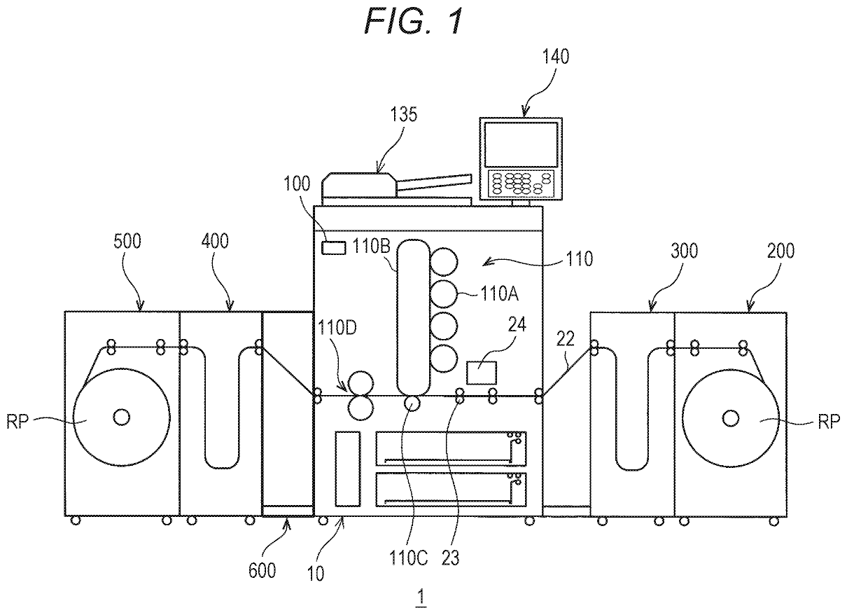

As illustrated in FIG. 1, the image forming apparatus 1 includes a paper feeder 200, a paper feeding adjuster 300, an apparatus main body 10, a paper ejection adjuster 400, and a paper ejector 500 which are sequentially arranged from an upper stage in a paper conveyance direction. The respective components are electrically and mechanically connected and it is possible to perform communication and paper conveyance between the respective components.

Roll paper or the like described later is conveyed from the paper feeder 200 to the paper ejector 500. Note that the number and type of devices constituting the image forming apparatus 1 are not particularly limited, and other devices such as a post-processing device may also be included. Additionally, the image forming apparatus may include only the apparatus main body, and the image forming apparatus including the apparatus main body and other respective components may constitute an image forming system.

The image forming apparatus 1 includes a conveyance path 22 all the way from the paper feeder 200 to the paper ejector 500, and the conveyance path 22 is provided with a conveyance roller 23 and the like. Roll paper RP is housed in the paper feeder 200, and the roll paper RP inside the paper feeder 200 is conveyed to subsequent components via the conveyance path 22.

The roll paper RP corresponds to one of the recording media in the present invention. Note that the recording medium of the present invention is not limited to the roll paper and may also be long paper that is folded and housed like continuous form paper. Additionally, the recording medium of the present invention is not necessarily the continuous recording medium, and it is possible to use a recording medium, such as long cut paper longer than regular size paper, on which a plurality of pages can be printed without reduction. In other words, the present invention can be used for, for example, long recording media such as the roll paper, the continuous form paper, and the long cut paper.

Also, the recording medium is not limited to paper and may be cloth, plastic, or the like.

The paper feeding adjuster 300 absorbs: a difference in a conveyance speed between the paper feeder 200 and the apparatus main body 10; and positional deviation of the paper.

The apparatus main body 10 includes, on a midway of the conveyance path 22, an image former 110 that is a device to form an image on the paper and electrophotographically form the image on the paper. The image former 110 includes photoreceptors 110A for respective colors, and an electric charger, an LD, a developing device, a cleaner, and the like (not illustrated) are provided around each of the photoreceptors 110A. The photoreceptors 110A for the respective colors contact an intermediate transfer belt 110B, and the intermediate transfer belt 110B can contact, at a secondary transfer member 110C, the roll paper RP located on the conveyance path 22.

Note that a skew sensor 24 that detects skew of the conveyed paper is provided on the conveyance path 22 on an upstream side of the image former 110. A configuration of the skew sensor 24 is not particularly limited and it is possible to use, for example, a sensor that obtains skew information by optically detecting both end faces of the paper. The skew sensor 24 corresponds to a skew detector of the present invention.

Additionally, another skew sensor may be arranged immediately before a print sheet reader 600 described later, and the two or more skew sensors may be installed including the skew sensor 24. In the present invention, the positions and the number of skew sensors are not limited to specific positions and the specific number.

Furthermore, a fixing device 110D is provided on a downstream side of the secondary transfer member 110C on the conveyance path 22. In a case of forming an image on the paper, each photoreceptor 110A is uniformly charged by each electric charger, and then a latent image is formed on each photoreceptor 110A by each LD based on image data. Then, toner is made to adhere by each developing device to develop the latent image formed on each photoreceptor 110A, thereby obtaining a toner image. The toner images on the respective photoreceptors 110A are transferred to the intermediate transfer belt 110B in a manner such that the toner images for the respective colors are superimposed each other, and the toner images on the intermediate transfer belt are transferred to the paper at the secondary transfer member 110C. The toner images transferred to the paper are fixed onto the paper by applying heat and pressure at the fixing device 110D.

An automatic document feeder (ADF) 135 is provided on top of a housing of the apparatus main body 10. The automatic document feeder (ADF) 135 automatically feeds a set document, and reads an image of the document by an image reader (CCD) of a scanner. Image data acquired by the reading is used for image formation and the like.

Additionally, an operation display 140 is provided on the top of the housing of the apparatus main body 10. The operation display 140 includes: an LCD including a touch panel; an operation key group; and the like, and can perform operation input and information display. In the operation display 140, it may be possible to set: processing content in a case where abnormality occurs in an image; and processing in accordance with skew of the roll paper (such as printing stop).

The apparatus main body 10 further includes a controller 100. The controller 100 includes a CPU, a ROM, a RAM, a program running in the CPU, and the like, and can control the entire image forming apparatus 1. The program running in the CPU includes a program of the present invention. In the present embodiment, the controller 100 corresponds to an inspection controller of the present invention.

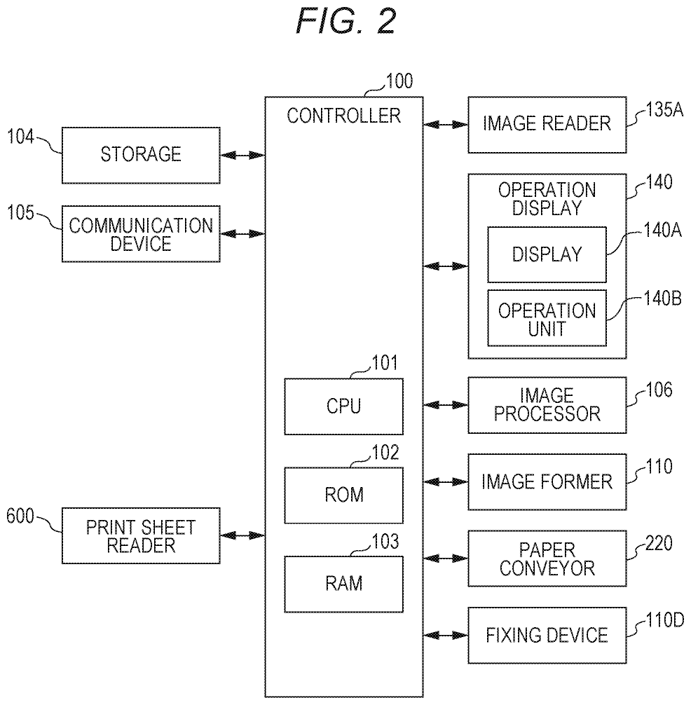

Next, a control block of the image forming apparatus 1 will be described based on FIG. 2.

The image forming apparatus 1 includes the controller 100. The controller 100 includes a CPU 101, a ROM 102, and a RAM 103. A program and parameters to control the image forming apparatus 1 are stored in the ROM 102, and the controller 100 reads, in the CPU 101, the program stored in the ROM 102, and can control operation of the respective components of the image forming apparatus 1. The controller 100 controls the entire image forming apparatus 1 and grasp a state thereof, and also performs: job management; image formation control; continuous-form paper conveyance control; paper reading control; and image inspection based on a read image. Therefore, the controller 100 can function as the inspection controller of the image inspection device, and in this case, the image inspection device of the present invention is included in the image forming apparatus.

Additionally, a storage 104 is connected to the controller 100, and the storage 104 includes a hard disk drive (HDD), a non-volatile memory, and the like capable of storing information in a non-volatile manner. The storage 104 can store: data of a read image read by the print sheet reader 600; reference image data for image inspection; print image data of a job; print setting information of a job; and the like. The print image data of the job can be obtained by reading a document with an image reader 135A included in the automatic document feeder (ADF) 135, or can be received from the outside.

Furthermore, the storage 104 stores: initial setting information of the apparatus main body 10; machine setting information such as process control parameters; and information and parameters relating to a sectioned region of a read image. Note that the above program and the parameters may be stored in a portable removable storage medium. The controller 100 reads the program and the parameters stored in the non-volatile memory and can determine normality/abnormality of an image based on a read image on paper while sectioning an inspection region in a certain unit.

The print sheet reader 600 is connected to the controller 100 in a controllable manner, and the controller 100 acquires the read image and determines normality/abnormality of the image. The print sheet reader 600 is provided with an inline sensor or the like that executes image reading. The controller 100 sets, as comparison image data, read image data read by the print sheet reader 600 and executes image inspection by comparing the read image data with the reference image data prepared in advance. At this time, skew of the paper is detected by the skew sensor 24, and the comparison image subjected to skew correction based on detected information thereof is used for determination.

A communication device 105 is connected to the controller 100. The communication device 105 can communicate with other devices via a network, and receives job data, image data, and the like from external devices on the network, and further can transmit image data, an image inspection result, and the like to the outside. For example, the communication device can transfer a print job and inspection information to other devices connected to the network, and can also transfer the image inspection result at this time.

An image processor 106 is connected to the controller 100. The image processor 106 executes image processing such as image data reading and image writing. At the time of image writing, the image processor can apply various kinds of image processing such as rotation, enlargement, and reduction of the image, addition of a page number, layout processing such as page aggregation, line thinning processing, density correction processing, and halftone processing to reproduce pseudo halftone.

A paper conveyer 220 is connected to the controller 100 in a controllable manner. The paper conveyer 220 includes the conveyance path 22, the conveyance roller 23, a motor (not illustrated) that drives a roller to be rotationally driven, and the like, and conveys the roll paper or the like.

Furthermore, the image former 110 is connected to the controller 100 in a controllable manner. The image former 110 forms an image by the electrophotographic process, and forms an image on a recording medium such as the roll paper. At the fixing device 110D, the image is fixed to the roll paper or the like on which the image is formed, and then printing is completed.

Additionally, the operation display 140 is connected to the controller 100 in a controllable manner. The operation display 140 includes the touch panel LCD, and can perform operation input and information display. In other words, the operation display 140 can input operation control conditions such as setting and operation commands in the image forming apparatus 1. For example, the operation display 140 can perform: setting for execution/non-execution of image inspection; setting for sectioning of an inspection region of a read image; and the like.

The operation display 140 can display desired information and, for example, can display a read image or an inspection image. The operation display 140 functions as both a display 140A and an operation unit 140B.

Note that, in the present embodiment, it has been described that the controller 100 is installed inside the housing of the apparatus main body 10, but the controller 100 may also be provided outside the housing of the apparatus main body 10.

Next, basic operation of the image forming apparatus 1 will be described.

In the controller 100, the roll paper RP is fed by the paper feeder 200 at the time of printing. The roll paper RP is conveyed by a paper conveyer 220, skew of the paper is detected by the skew sensor 24, and detected information is transmitted to the controller 100.

Additionally, the controller 100 controls the image former 110. The image former 110 writes a toner image on each of the photoreceptors based on image data by the electrophotographic process, transfers the toner image written on each of the photoreceptors to the intermediate transfer belt 110B, and secondarily transfers the toner image to the roll paper fed by the paper feeder 200, and then fix the image at the fixing device 110D.

The image data may be acquired through the automatic document feeder (ADF) 135 or may be acquired from the outside via the communication device 105.

The roll paper on which the image is formed is read by the print sheet reader 600, and image inspection is executed based on the read image in the controller 100. After that, the roll paper is conveyed to the paper ejector 500 via the paper ejection adjuster 400 along the conveyance path 22 and is wound up at the paper ejector 500.

Note that, in the present embodiment, it has been described that the controller 100 functions as the inspection controller of the present invention, but the print sheet reader 600 may include the inspection controller to execute the image inspection. In this case, the print sheet reader 600 functions as the image inspection device.

Alternatively, the inspection controller may be provided outside the image forming apparatus via the communication device or the like, and for example, the inspection controller may be provided in a server or a terminal to determine normality/abnormality of an image. In this case, the server or the terminal functions as the image inspection device.

Next, image reading in the image forming apparatus 1 will be described.

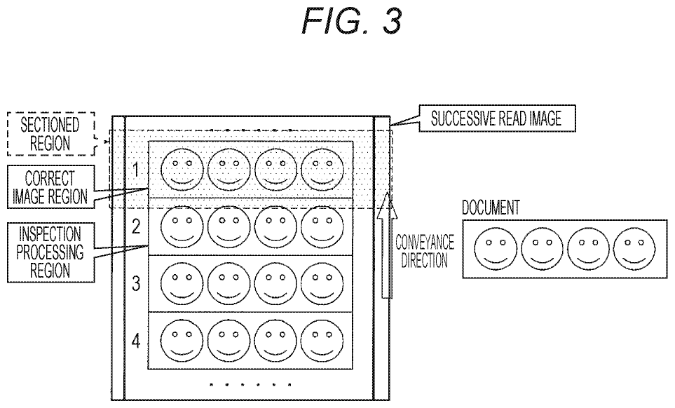

FIG. 3 is a diagram illustrating a concept of a continuous read image read by the reader. In the continuous read image, an image row of each page illustrated on a right side of FIG. 3 is positioned in succession along the paper conveyance direction.

In image reading, a sectioned region is set corresponding to a page region assumed in accordance with each image array, and an image region is included in the sectioned region. In the present embodiment, a first image region is set as a correct image region, and image regions on next and subsequent pages are set as inspection regions. Note that a correct image may be prepared in advance.

In a state in which there is no skew of the paper, an image is read per predetermined sectioned region and set as a comparison image as illustrated in FIG. 3, and it is possible to determine whether the comparison image is correct or abnormal by comparing the comparison image with the correct image. In a case where the image is abnormal, a warning can be issued as a defective print or printing can be stopped.

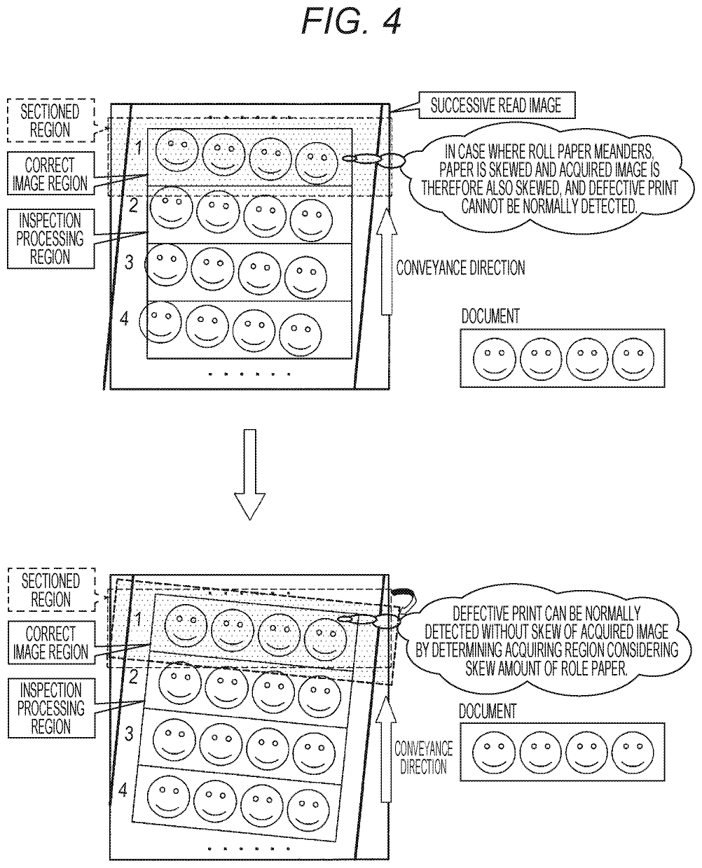

On the other hand, when the roll paper meanders and becomes skewed, the image is positioned in a skewed direction with respect to a sectioned region as illustrated in an upper part of FIG. 4. As a result, the read image is also skewed, and defective print detection cannot be normally executed in the comparison with the correct image.

Therefore, in the present embodiment, the skew sensor 24 detects the skew of the roll paper. Additionally, in the present embodiment, after a read image is acquired in the predetermined sectioned region, comparison processing can be executed while inclining the read image of the inspection region in accordance with detected information by the skew sensor as illustrated in a lower part of FIG. 4.

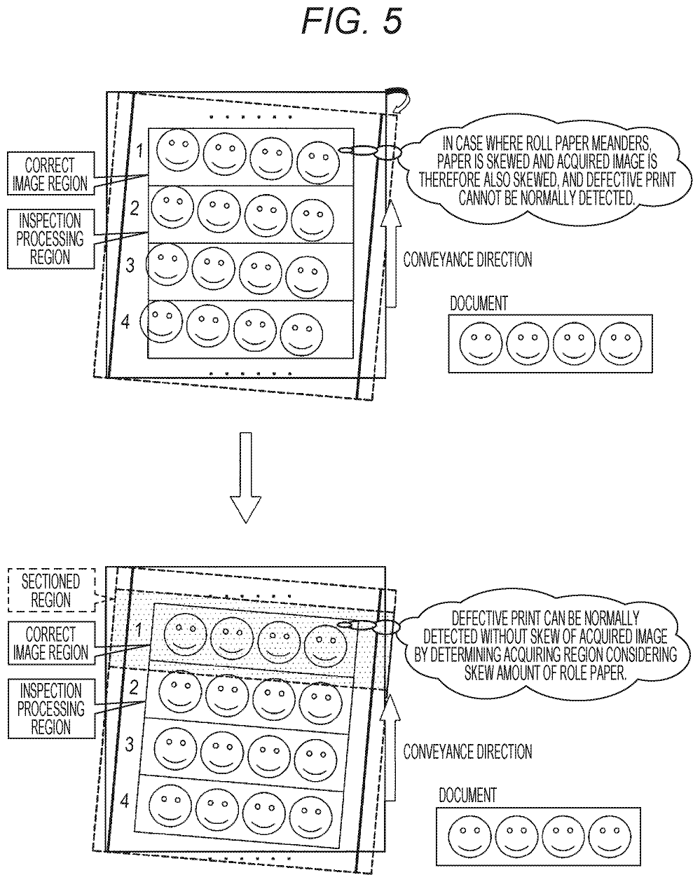

Additionally, as illustrated in an upper part of FIG. 5, it is conceivable to incline a region including successive read images in consideration of the skew of the roll paper. However, even when the inspection region is sectioned in the certain unit and an image on the inspection region is set as a comparison image after inclining the successive read images, the acquired image remains skewed if the sectioned region is kept as it is. Therefore, the defective print detection cannot be properly executed.

At this time, as illustrated in a lower part of FIG. 5, the sectioned region is inclined and a cut image is acquired. Then, the acquired image is used as a comparison image for determination.

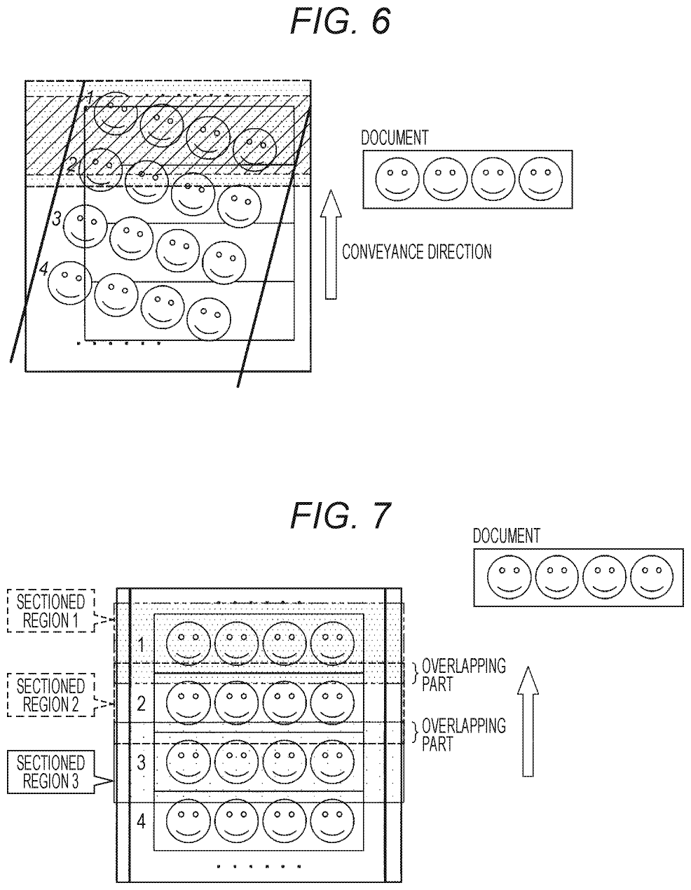

With the above-described procedure, even in the case where the roll paper is skewed, the corrected image is acquired based on the skew, and normality/abnormality of the image can be determined. However, if a cut-out region is kept as it is even though the skew is increased, a part of the cut-out image is cut off as illustrated in FIG. 6, and there may be a case where the defective print detection cannot be normally executed. In FIG. 6, image chipping occurs at a left end and a right end of the read image, and the defective print determination cannot be normally performed in comparison with the correct image.

In this case, the sectioned region is enlarged larger than the initially preset region in the paper conveyance direction, and it becomes possible to execute reading so as not to cause image chipping. Note that in a case where the image chipping cannot be eliminated even though the sectioned region is enlarged to a predetermined size, and a warning can be issued as an error or printing can be stopped.

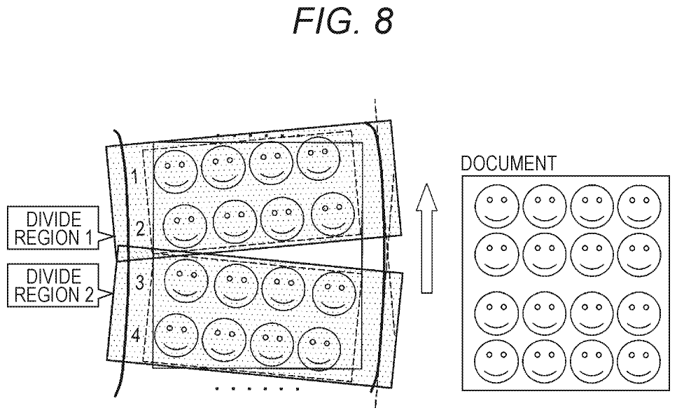

Also, in a case where it is necessary to secure a large region so as to prevent, in the sectioned region of the certain unit, the image chipping caused by the skew, there may be a case where an image of each sectioned region is read in a manner overlapping with an image of an adjacent sectioned region as illustrated in FIG. 7. In each comparison image, normality/abnormality is determined excluding the overlapping image. Note that the overlapping image is removed at the time of the determination, and therefore, it is desirable to execute the determination after completion of inspection in which the overlapping part is removed in a sectioned region to be inspected next.

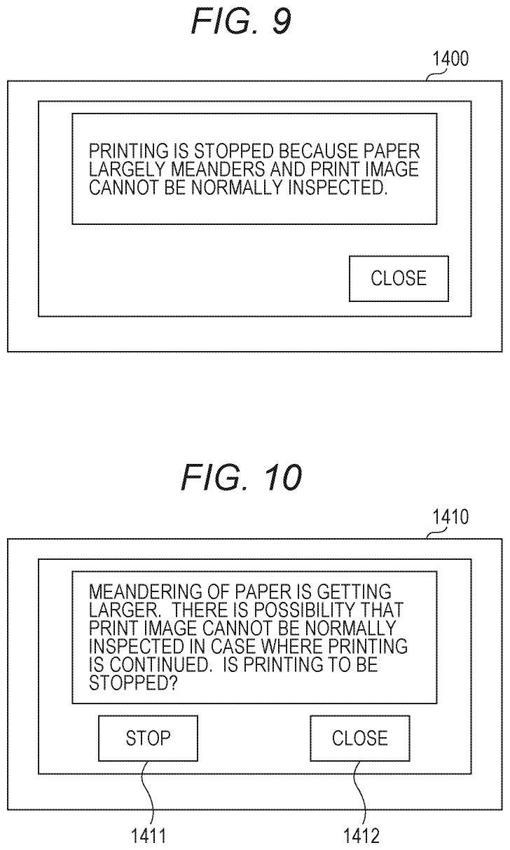

Additionally, in a case where a length of a sectioned region (such as one page) is long as illustrated on a right diagram of FIG. 8, there is a case where skew of the paper is different between the leading end and the tail end of the roll paper. In this case, the sectioned region is divided in the paper conveyance direction as illustrated in a left diagram of FIG. 8, and the image may be inspected in each of the divided regions.

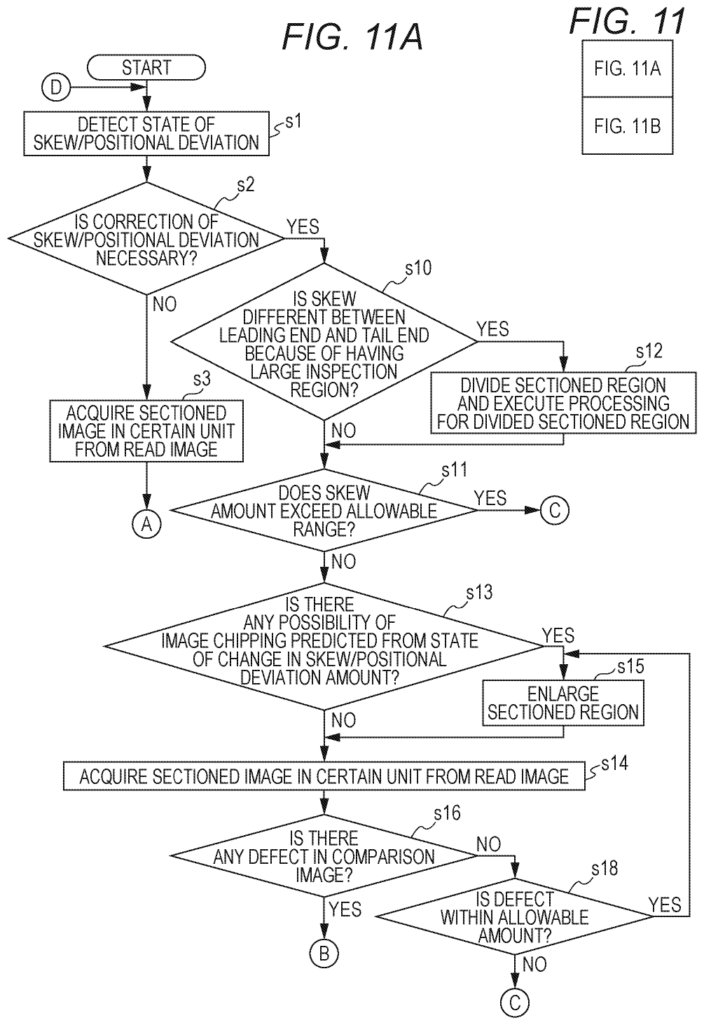

Note that in a case where the skew of the paper exceeds a set value (for example, in a case where the meandering is large), the image cannot be normally inspected. Therefore, a warning can be issued or printing can be stopped. FIG. 9 illustrates an example in which the warning is issued on a warning screen 1400 of the operation display 140, and the printing is stopped because the skew exceeds an allowable range. Note that a notification of a warning and the like may be provided to a server, a terminal, or the like via the network or the like.

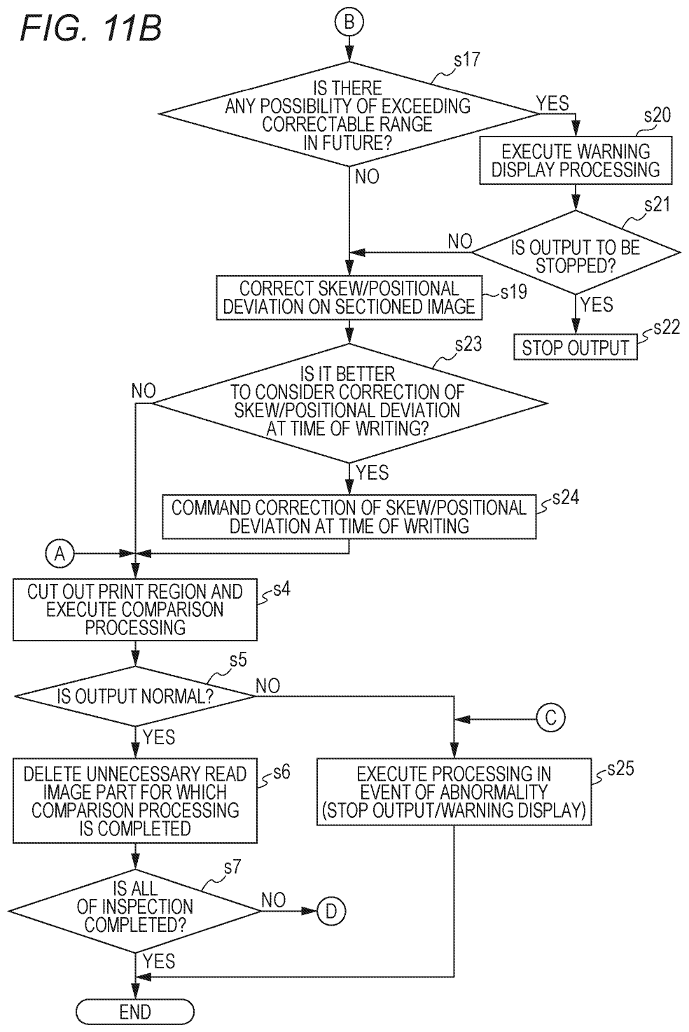

Additionally, it is possible to monitor the skew of the paper to grasp tendency, and predict a value thereof. In a case where it is predicted that the skew exceeds the allowable range in the future, a warning of a possibility that the inspection cannot be normally executed may be provided so as to be able to issue a stop command. FIG. 10 illustrates a warning command screen 1410 displayed on the operation display 140, in which printing can be stopped by pressing a stop button 1411. When a close button 1412 is pressed, the screen can be closed and the printing can be continued.

Note that in the case of detecting the skew of the paper, the skew of the recording medium can be detected by setting a reading region wider than a width of the recording medium, detecting ends of the recording medium, and analyzing an image. At this time, not only the skew of the paper but also positional deviation of the paper can be detected. In a case of executing correction based on the skew, the correction may be executed considering the positional deviation of the paper. At this time, the positional deviation may be monitored in a manner similar to the skew so as to predict tendency thereof.

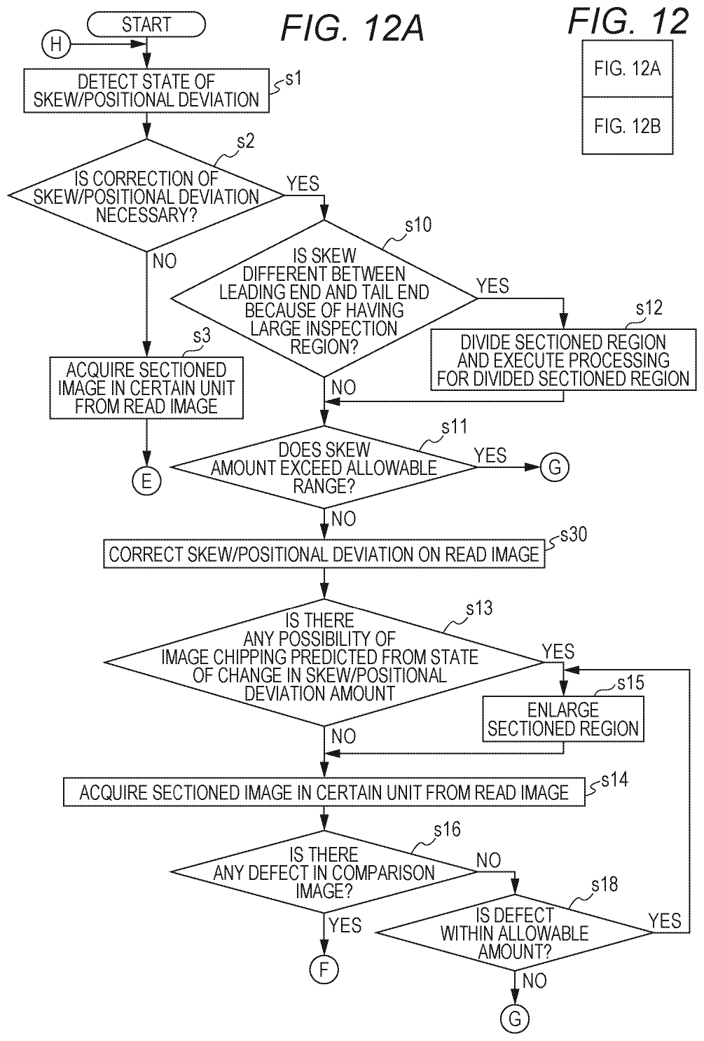

A procedure of detecting skew of roll paper and inspecting an image will be described by using a flowchart of FIGS. 11A and 11B. The following procedure is executed under the control of the controller.

The paper is detected by the skew sensor (step s1), and whether correction of the skew and the positional deviation is necessary is determined based on the detected information (step s2).

When the correction of the skew and the positional deviation is not necessary (No in step s2), a sectioned image is acquired in a certain unit from a read image (step s3). The certain unit is, for example, a page unit. However, the certain unit is not limited thereto, and an appropriate range can be preliminarily set.

Next, a print region is cut out to obtain a comparison image, and comparison processing is executed to compare the comparison image with the correct image (step s4).

As a result of the comparison processing, whether output is normal is determined (step s5). In a case where it is determined that the output is normal (Yes in step s5), an unnecessary read image part for which the comparison processing is completed is deleted from the storage (step s6), and whether all of inspection is completed is determined (step s7). In a case where all of the inspection is not completed (No in step s7), the processing returns to step s1, and the processing from detection of the state of skew/positional deviation is continued. In a case where all of the inspection is completed (Yes in step s7), the processing ends. Note that, in the following description, the description will be provided assuming that the skew and the positional deviation of the roll paper are detected and considered, but in the present invention, only the skew of the roll sheet may be considered.

In a case where the output is not normal in step s5 (No in step s5), processing in the event of abnormality (defective print determination) is executed (step s25). As the processing, it is possible to execute stopping the output, displaying a warning, and the like. In the present invention, the processing in the event of image abnormality is not particularly limited. After completion of the processing in the event of abnormality, the entire processing ends. Note that, in the event of abnormality, the processing may proceed to step s7 and continue the output without stopping the output.

In step s2, in a case where correction of the skew/positional deviation is necessary (Yes in step s2), whether the skew is different between a leading end and a tail end of an inspection region due to having the large inspection region (sectioned region of one page or the like) is determined (step s10). In a case where the skew is not different between the leading end and the tail end (No in step s10), whether a skew amount exceeds the allowable range is determined (step s11). In a case where the skew is different between the leading end and the tail end (Yes in step s10), the sectioned region is divided in the conveyance direction, setting is made such that the processing is executed on each of the divided sectioned regions (step s12), and the processing proceeds to step s11.

In a case where the skew amount does not exceed the allowable range in step s11 (No in step s11), whether there is a possibility of image chipping is determined from a state of change in the skew/positional deviation amount (step s13). In a case where the skew amount exceeds the allowable range in step s11 (Yes in step s11), the processing proceeds to step s25, and the processing in the event of abnormality is executed as described above.

In a case where there is no possibility of image chipping determined from the state of the change in the skew/positional deviation amount (No in step s13), a sectioned image is acquired in the certain unit from the read image (step s14). In a case where there is a possibility of image chipping determined from the state of the change in skew/positional deviation amount (Yes in step s13), the sectioned region is enlarged (step s15), and the processing proceeds to step s14 described above.

After acquiring the sectioned image in step s14, whether there is any defect in the comparison image is determined (step s16). When there is no defect in the comparison image (Yes in step s16), whether there is any possibility that the skew/positional deviation exceeds a correctable range in the future is determined from tendency of the skew/positional deviation (step s17).

In a case where there is a defect in the comparison image (No in step s16), whether the defect is within an allowable amount is determined (step s18). The allowable amount is preliminarily set. In a case where the defect is within the allowable amount (Yes in step s18), a sectioned region is enlarged in step s15 described above to acquire a sectioned image (step s16).

In a case where it is not determined from the tendency of the skew/positional deviation that there is the possibility that the skew/positional deviation exceeds the correctable range in the future (No in step s17), the skew/positional deviation is corrected on the sectioned image (step s19). In a case where it is determined from the tendency of the skew/positional deviation that there is the possibility that the skew/positional deviation exceeds the correctable range in the future (Yes in step s17), warning display processing is executed (step s20), and whether to stop the output is determined (step s21). Whether to stop the output may be input by an operator. Alternatively, whether to stop the output or not may be preliminarily defined by machine setting. In the case of not stopping the output (No in step s21), the processing proceeds to step s19, and skew/positional deviation is corrected on the sectioned image as described above. In the case of stopping the output (Yes in step s21), stop processing is executed (step s22).

After the skew/positional deviation are corrected in step s19 as described above, whether to consider correction of the skew/positional deviation at the time of writing is determined (step s23). In this determination, the determination may be made based on only a detection result of the above-described skew sensor 24.

Alternatively, the determination may be made by installing a skew sensor immediately before the print sheet reader 600 as well and considering detected information thereof together. For example, in a case where a burden of correction at the time of reading can be reduced by reducing the skew/positional deviation of the image by executing correction at the time of writing, the correction can be executed at the time of writing.

In a case where it is not better to consider the correction at the time of writing (No in step s23), the processing proceeds to step s4, and the print region is cut out and the comparison processing is executed as described above. In a case where it is better to consider the correction at the time of writing (Yes in step s23), execution of the correct of the skew/positional deviation at the time of writing is commanded (step s24), and the processing proceeds to step s4.

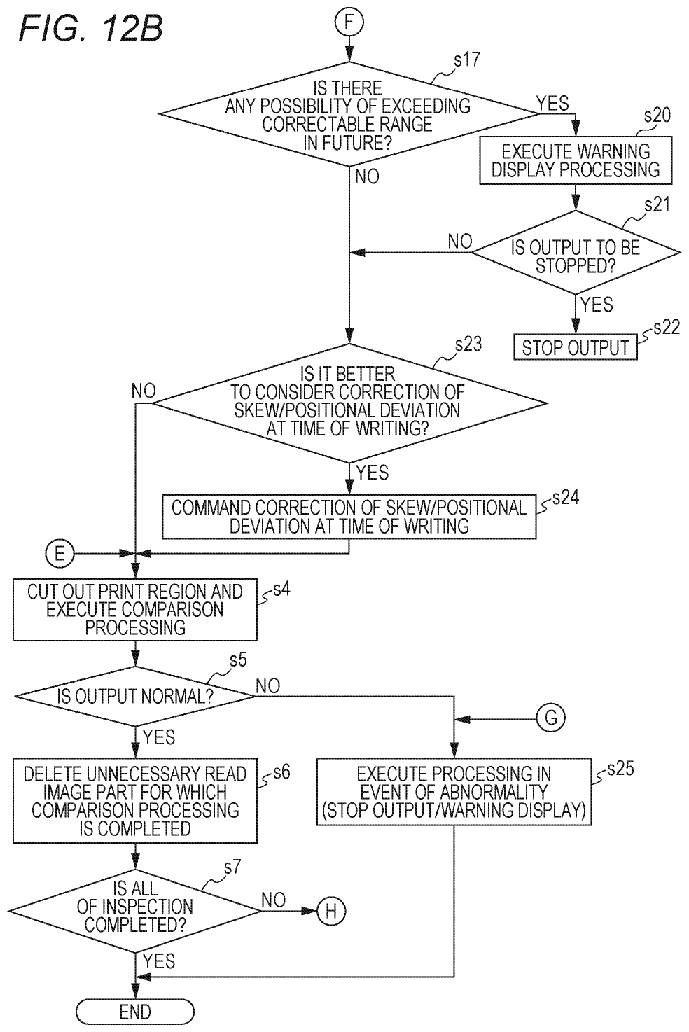

In the above example, it has been described that the skew/positional deviation is corrected on the sectioned image acquired from the read image, but the skew/positional deviation may be corrected on the read image, and then a sectioned image may be acquired. In the following, such an example will be described based on a flowchart of FIGS. 12A and 12B. The following procedure is executed under the control of the controller.

The paper is detected by the skew sensor (step s1), and whether correction of the skew and the positional deviation is necessary is determined based on the detected information (step s2).

When the correction of the skew and the positional deviation is not necessary (No in step s2), a sectioned image is acquired in a certain unit from a read image (step s3). The certain unit is, for example, a page unit. However, the certain unit is not limited thereto, and an appropriate range can be preliminarily set.

Next, a print region is cut out to obtain a comparison image, and comparison processing is executed to compare the comparison image with the correct image (step s4).

As a result of the comparison processing, whether output is normal is determined (step s5). In a case where the output is normal (Yes in step s5), an unnecessary read image part for which the comparison processing is completed is deleted from the storage (step s6), and whether all of inspection is completed is determined (step s7). In a case where all of the inspection is not completed (No in step s7), the processing returns to step s1, and the processing from detection of the state of skew/positional deviation is continued. In a case where all of the inspection is completed (Yes in step s7), the processing ends.

In a case where the output is not normal in step s5 (No in step s5), processing in the event of abnormality (defective print determination) is executed (step s25). As the processing, it is possible to execute stopping the output, displaying a warning, and the like. In the present invention, the processing in the event of image abnormality is not particularly limited. After that, the processing ends. Note that, in the event of abnormality, the processing may proceed to step s7 and continue the output without stopping the output.

In step s2, in a case where correction of the skew/positional deviation is necessary (Yes in step s2), whether the skew is different between the leading end and the tail end of an inspection region because of having the large inspection region (sectioned region of one page or the like) is determined (step s10). In a case where the skew is not different between the leading end and the tail end (No in step s10), whether the skew amount exceeds the allowable range is determined (step s11). In a case where the skew is different between the leading end and the tail end (Yes in step s10), the sectioned region is divided in the conveyance direction, setting is made such that the processing is executed on each of the divided sectioned regions (step s12), and the processing proceeds to step s11.

In a case where the skew amount does not exceed the allowable range in step s11 (No in step s11), the skew/positional deviation is corrected on the read image (step s30). In a case where the skew amount exceeds the allowable range in step s11 (Yes in step s11), the processing proceeds to step s25, and the processing in the event of abnormality is executed as described above.

After the processing of step s30, whether there is a possibility of image chipping is determined from a state of change in the skew/positional deviation amount (step s13).

In a case where there is no possibility of image chipping determined from the state of change in the skew/positional deviation amount (No in step s13), a sectioned image is acquired in the certain unit from the read image (step s14). In a case where there is a possibility of image chipping determined from the state of the change in skew/positional deviation amount (Yes in step s13), the sectioned region is enlarged (step s15), and the processing proceeds to step s14 described above.

After acquiring the sectioned image in step s14, whether there is any defect in the comparison image is determined (step s16). In a case where there is no defect in the comparison image (Yes in step s16), whether there is a possibility that the skew/positional deviation exceeds the correctable range in the future is determined from the tendency of skew/positional deviation (step s17).

In a case where there is a defect in the comparison image (No in step s16), whether the defect is within an allowable amount is determined (step s18). The allowable amount is preliminarily set. In a case where the defect is within the allowable amount (Yes in step s18), a sectioned region is enlarged in step s15 described above to acquire a sectioned image (step s16).

In a case where it is not determined from the tendency of skew/positional deviation that there is the possibility of exceeding the correctable range in the future (No in step s17), whether it is better to consider correction of the skew/positional deviation at the time of writing is determined (step s23). In a case where it is not better to consider the correction at the time of writing (No in step s23), the processing proceeds to step s4, and the print region is cut out and the comparison processing is executed as described above. In a case where it is better to consider the correction at the time of writing (Yes in step s23), execution of the correct of the skew/positional deviation at the time of writing is commanded (step s24), and the processing proceeds to step s4.

In a case where it is determined from the tendency of the skew/positional deviation that there is the possibility that the skew/positional deviation exceeds the correctable range in the future (Yes in step s17), warning display processing is executed (step s20), and whether to stop the output is determined (step s21). Whether to stop the output may be input by an operator. Alternatively, whether to stop the output or not may be preliminarily defined by machine setting. In the case of not stopping the output (No in step s21), the processing proceeds to step s21, and skew/positional deviation is corrected on the sectioned image as described above. In the case of stopping the output (Yes in step s21), stop processing is executed (step s22).

Although embodiments of the present invention have been described and illustrated in detail, the disclosed embodiments are made for purposes of illustration and example only and not limitation, and a modification can be made on the above-described embodiments as necessary unless otherwise departing from the scope of the present invention. The scope of the present invention should be interpreted by terms of the appended claims.

What is claimed is:

1. An image inspection device comprising:
a hardware processor that acquires a read image obtained by reading an image on a recording medium on which the image is formed, prepares a comparison image from the read image by sectioning an inspection region in a certain unit, and determines normality/abnormality of an image based on the comparison image; and
a skew detector that detects a skewed state caused by meandering of the recording medium, wherein
the hardware processor receives detected information from the skew detector, and inclines an image on the inspection region in accordance with the detected information to determine the normality/abnormality of the image.

2. The image inspection device according to claim 1, wherein the hardware processor inclines the image on the inspection region in accordance with the detected information from the skew detector after sectioning the inspection region in the certain unit, and sets the inclined image as the comparison image.

3. The image inspection device according to claim 1, wherein the hardware processor sections the inspection region in the certain unit after inclining the read image in accordance with the detected information from the skew detector, and sets an image on the sectioned inspection region as the comparison image.

4. The image inspection device according to claim 1, wherein in a case where image chipping occurs at the time of sectioning the inspection region, the hardware processor sections an image while enlarging the sectioned region.

5. The image inspection device according to claim 1, wherein the skew detectors are arranged in at least two places for time of image writing and time of image reading for inspection, and the hardware processor corrects skew of the image based on two pieces of detected information of the two skew detectors.

6. The image inspection device according to claim 1, wherein the inspection region is a print region out of the region sectioned in the certain unit.

7. The image inspection device according to claim 1, wherein the hardware processor sets a reading region wider than a width of the recording medium and detects a state of skew of the recording medium or a state of skew and positional deviation of the recording medium by detecting ends of the recording medium and executing image analysis.

8. The image inspection device according to claim 1, wherein in a case where the inspection region is larger than a predetermined size, the inspection region is divided and cut out, and inspection is executed in a divided unit.

9. The image inspection device according to claim 1, wherein a width which may be deviated due to meandering of the recording medium is predicted, and image reading is executed in a range larger than a predetermined range.

10. The image inspection device according to claim 1, wherein the sectioned region in the certain unit includes a region overlapping with an adjacent sectioned region in order to secure a region in which occurrence of image chipping caused by the skew is prevented.

11. The image inspection device according to claim 1, wherein the hardware processor also detects positional deviation of a continuous-form transfer medium at the time of skew detection and corrects an image.

12. The image inspection device according to claim 1, wherein the hardware processor deletes data of read images obtained by successive reading, and the deletion is executed in a unit of the sectioned region for which inspection excluding an overlapping part used in a next sectioned region is completed.

13. The image inspection device according to claim 1, wherein in a case where a skew amount of an image exceeds an allowable range, the hardware processor executes one or both of a warning display and print operation stop.

14. The image inspection device according to claim 1, wherein a state of change in a detected skew amount or a state of change in the detected skew amount and a detected positional deviation amount is monitored, the skew amount or the skew amount and the positional deviation amount in future is/are predicted, and correction is executed to incline the image on the inspection region based on the predicted skew amount or the skew amount and the positional deviation amount which are predicted, and in a case of determining that image chipping occurs in a current state of the sectioned region as a result of the correction, the sectioned region is enlarged in advance more than the region currently set.

15. The image inspection device according to claim 1, wherein the hardware processor monitors a state of change in a detected skew amount or a state of change in a skew amount and a positional deviation amount at the time of writing, predicts the skew amount or the skew amount and the positional deviation amount in future, and executes writing correction in advance at the time of writing based on the skew amount or the skew amount and the positional deviation amount.

16. The image inspection device according to claim 14, wherein the hardware processor monitors the state of the change in the skew amount or the state of the change in the skew amount and the positional deviation amount, predicts the skew amount or the skew amount and the positional deviation amount in future, and displays a warning in advance in a case of determining that the skew amount or the skew amount and the positional deviation amount exceeds/exceed a correctable range.

17. The image inspection device according to claim 1, further comprising a reader that reads an image on the recording medium on which the image is formed.

18. The image inspection device according to claim 1, further comprising an image former that forms an image on the recording medium.

19. A non-transitory recording medium storing a computer readable program executed in a hardware processor that acquires a read image obtained by reading an image on a recording medium on which the image is formed, prepares a comparison image from the read image by sectioning an inspection region in a certain unit, and determines normality/abnormality of an image based on the comparison image, the program causing the hardware processor to perform
receiving skew information of the recording medium, and inclining an image on the inspection region in accordance with the skew information to determine the normality/abnormality of the image.
